(19) United States
(12) Patent Application Publication
(10) Pub. No.: US 2007/0281151 A1
(43) Pub. Date: Dec. 6, 2007

(54) FILM-BACKED LABELS

(75) Inventors: Petra Schocker, Buerstadt (DE); Cornelis Petrus Beyers, Altrip (DE); Stefan Kirsch, Nieder-Olm (DE); Ines Pietsch, Speyer (DE); Michael Kutschera, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/754,687

(22) Filed: May 29, 2007

(30) Foreign Application Priority Data
Jun. 1, 2006 (EP) 06114862.3

(51) Int. Cl. B32B 27/32; B32B 7/12; C09D 5/02

(52) U.S. Cl. 428/343; 524/556; 428/523

(57) ABSTRACT

Use of an aqueous pressure-sensitive adhesive for producing self-adhesive articles, wherein the aqueous pressure-sensitive adhesive comprises a water-dispersed polymer binder (polymer for short) and a water-dissolved polymer containing hydrophilic groups selected from primary amino groups and hydroxyl groups (solution polymer for short).

The invention relates to the use of an aqueous pressure-sensitive adhesive for producing self-adhesive articles, especially film-backed labels, wherein the aqueous pressure-sensitive adhesive comprises a water-dispersed polymer binder (polymer for short) and a water-dissolved polymer containing hydrophilic groups selected from primary amino groups and hydroxyl groups (solution polymer for short).

Film-backed labels are composed essentially of a polymeric sheet backing with a layer of pressure-sensitive adhesive applied to it. For numerous applications the backing is transparent. Water exposure is frequently accompanied by what is referred to as “blushing”, by which is meant a clouding in the adhesive layer as a result of the penetration of water. Blushing impairs the performance properties; in the case of transparent film-backed labels in particular, of course, the clouding adversely affects the visual appearance.

In the case of aqueous polymer dispersions it is known from, for example, EP-A 1 378 527, EP-A 623 659 or WO 98/44064, to lessen the blushing by means of specific constituent components in the dispersed polymer. The result achieved is still not fully satisfactory. Moreover, specially prepared polymers of this kind are then suitable generally only for special-purpose uses. There is therefore a desire for a simple method of preventing the blushing, as far as possible completely.

It was an object of the present invention, therefore, to lessen or avoid the effect of blushing, using extremely simple measures.

Found accordingly has been the use defined at the outset: Also found have been self-adhesive articles, especially film-backed labels, which are obtainable through such use.

The present invention relates to the use of an aqueous pressure-sensitive adhesive.

The pressure-sensitive adhesive comprises a water-dispersed polymer binder.

### The Polymer

The polymer is composed preferably of at least 40% by weight, more preferably of at least 60% by weight, very preferably of at least 80% by weight, of what are called principal monomers.

The principal monomers are selected from C₁-C₂₀ alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, or mixtures of these monomers.

In particular the polymer is composed of at least 60% by weight, more preferably at least 80% by weight, and very preferably at least 90% by weight of C₁ to C₂₀ alkyl (meth)acrylates.

Examples include (meth)acrylic acid alkyl esters having a C₁-C₁₀ alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Vinyl esters of carboxylic acids having 1 to 20 carbon atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably, styrene.

Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether or vinyl isobutyl ether. Preference is given to vinyl ethers of alcohols comprising 1 to 4 carbon atoms.

Hydrocarbons having 4 to 8 carbon atoms and two olefinic double bonds include ethylene, propylene, butadiene, isoprene, and chloroprene.

Preferred principal monomers are the C₁ to C₁₀ alkyl acrylates and methacrylates, especially C₁ to C₈ alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate, and 2-ethylhexyl acrylate, styrene, and mixtures of these monomers.

Besides the principal monomers the polymer may comprise further monomers, examples being monomers having carboxylic acid, sulfonic acid or phosphonic acid groups (acid monomers for short). Carboxylic acid groups are preferred. Examples that may be mentioned include acrylic acid, methacrylic acid, itaconic acid, maleic acid, and fumaric acid. The amount of acid monomers in the polymer can be from 0 to 10% by weight, in particular from 0.05 to 5% by weight, based on the polymer. The acid groups can be present in the form of their salts.

Further monomers are also, for example, monomers comprising hydroxyl groups, especially C₁-C₁₀ hydroxyalkyl (meth)acrylates, and (meth)acrylamide.

As further monomers mention may also be made of phenyloxyethyl glycol mono(meth)acrylate, glycidyl acrylate, glycidyl methacrylate, and amino (meth)acrylates such as 2-aminoethyl (meth)acrylate.

As further monomers mention may also be made of crosslinking monomers.

Further monomers are generally used in minor amounts; their proportion total is preferably below 10% by weight, in particular below 5% by weight.

Monomers containing hydroxyl groups or primary amino groups are used, if at all, preferably only in amounts less than 3% by weight, in particular less than 1% by weight. The use of monomers containing hydroxyl groups or amino groups, or of other further monomers, is not mandatory for the purposes of this invention.

The polymers are prepared in one preferred embodiment by emulsion polymerization, and the product is therefore an emulsion polymer.

Emulsion polymerization involves ionic and/or nonionic emulsifiers and/or protective colloids or stabilizers as surface-active compounds.

A detailed description of suitable protective colloids is found in Houben-Weyl, Methoden der organischen Chemie, Volume XIV/1, Makromolekulare Stoffe [macromolecular compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are typically below 2000 g/mol. Where mixtures of surface-active substances are used the individual components must, as will be appreciated, be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

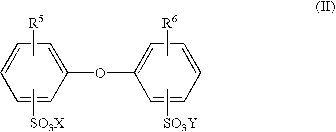

in which R⁵ and R⁶ are hydrogen or C₄ to C₁₄ alkyl and are not simultaneously hydrogen, and X and Y can be alkali metal ions and/or ammonium ions. Preferably R⁵ and R⁶ are linear or branched alkyl radicals having 6 to 18 carbon atoms or hydrogen, and in particular having 6, 12 and 16 carbon atoms, R⁵ and R⁶ not both simultaneously being hydrogen. X and Y are preferably sodium, potassium or ammonium ions, with sodium being particularly preferred. Particularly advantageous compounds II are those in which X and Y are sodium, R⁵ is a branched alkyl radical having 12 carbon atoms, and R⁶ is hydrogen or R⁵. It is common to use technical mixtures having a fraction of 50% to 90% by weight of the monoalkylated product, an example being Dowfax® 2A1 (trade mark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Emulsifier trade names are, for example, Dowfax®2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065, Disponil FES 77, Lutensol AT 18, Steinapol VSL, Emulphor NPS 25.

For the present invention ionic emulsifiers or protective colloids are preferred. Particular preference is given to ionic emulsifiers, especially salts and acids, such as carboxylic acids, sulfonic acids, and sulfates, sulfonates or carboxylates.

The surface-active substance is used typically in amounts of 0.1 to 10 parts by weight, preferably 0.2 to 5 parts by weight, based on 100 parts by weight of the monomers to be polymerized.

Water-soluble initiators for emulsion polymerization are, for example, ammonium salts and alkali metal salts of peroxydisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures: for example, a mixture of the sodium salt of hydroxymethanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1 to 30% by weight, preferably 0.5 to 20% by weight, more preferably 1.0 to 10% by weight, based on the solution.

The amount of the initiators is generally 0.1 to 10% by weight, preferably 0.5 to 5% by weight, based on the monomers to be polymerized. It is also possible for two or more different initiators to be used for the emulsion polymerization.

In the course of the polymerization, regulators, which lower the molar mass, can be used in amounts for example of from 0 to 0.8 part by weight, based on 100 parts by weight of the monomers to be polymerized. Suitable regulators are, for example compounds having a thiol group, such as tert-butyl mercaptan, thioglycolic acid ethylacrylic esters, mercaptoethynol, mercaptopropyltrimethoxysilane or tert-dodecyl mercaptan.

The emulsion polymerization takes place in general at 30 to 130, preferably 50 to 90° C. The polymerization medium may be composed either of water alone or of mixtures of water and water-miscible liquids such as methanol. Preferably only water is used. The emulsion polymerization may be conducted either as a batch process or in the form of a feed process, including a staged or gradient procedure. Preference is given to the feed process, in which a portion of the polymerization mixture is introduced as an initial charge and heated to the polymerization temperature, the polymerization of this initial charge is commenced, and then the remainder of the polymerization mixture is supplied to the polymerization zone, typically by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial polymerization charge.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove residual monomers it is common to add initiator after the end of the actual emulsion polymerization as well, i.e., after a monomer conversion of at least 95%.

With the feed process, the individual components can be added to the reactor from the top, through the side, or from below, through the reactor floor.

In the case of emulsion polymerization, aqueous polymer dispersions with solids contents generally of 15 to 75% by weight, preferably of 40 to 75% by weight, are obtained.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at high solids content is the improved coating behavior at high solids contents. One or more new generations of particles can be produced at any point in time. This point in time depends on the particle size distribution which is targeted for a low viscosity.

The polymer thus prepared is used preferably in the form of its aqueous dispersion.

The average particle size of the polymer particles dispersed in the aqueous dispersion is preferably less than 400 nm, in particular less than 200 nm. With particular preference the average particle size is situated between 140 and 200 nm.

By average particle size is meant here the d₅₀ value of the particle size distribution; that is, 50% by weight of the total mass of all the particles have a diameter smaller than the d₅₀ value. The particle size distribution can be determined in a known way using the analytical ultracentrifuge (W. Mäschtle, Makromolekulare Chemie 185 (1984), pages 1025-1039).

The pH of the polymer dispersion is adjusted preferably to a level of more than 4.5, in particular to a pH value between 5 and 8.

The glass transition temperature of the polymer, or of the polymer, is preferably −60 to 0° C., more preferably −60 to −10° C., and very preferably −60 to −20° C.

The glass transition temperature can be determined by typical methods such as differential thermoanalysis or differential scanning calorimetry (see, e.g. ASTM 3418/82, midpoint temperature).

### The Solution Polymer

The pressure-sensitive adhesive further comprises a water-dissolved polymer containing hydrophilic groups, selected from primary amino groups (—NH2) and hydroxyl groups (solution polymer for short).

The amount of hydrophilic groups in the solution polymer is preferably at least 0.05 mol, in particular at least 0.15 mol, more preferably at least 0.3 mol, very preferably at least 0.5 mol, or, in one particular embodiment, at least 0.7 mol or at least 1 mol of hydrophilic groups per 100 g of solution polymer. The amount of hydrophilic groups is generally not more than 2.3 mol/100 g polymer, which corresponds arithmetically to the amount of primary amino groups in the polyvinylamine or of hydroxyl groups in the polyvinyl alcohol; in particular the amount is not more than 2.0 mol/100 g polymer.

Solution polymers containing hydroxyl groups or primary amino groups are common knowledge.

The solution polymers are preferably likewise obtainable by free-radical addition polymerization of ethylenically unsaturated compounds.

As a solution polymer containing hydroxyl groups mention may be made, for example, of polyvinyl alcohol or polyvinyl ether or copolymers of vinyl alcohol or vinyl ether, the polyvinyl ethers or copolymers having undergone partial or complete hydrolysis, so that a hydroxyl group instead of the ether group is attached to the polymer backbone. Suitable examples include polyvinyl ethers or copolymers with a degree of ether group hydrolysis of 10 to 100 mol %.

As a solution polymer containing primary amino groups mention may be made, for example, of polyvinyl amine or polyvinyl formamide or copolymers of vinyl amine or vinyl formamide, the polyvinyl formamides or copolymers having undergone partial or complete hydrolysis, so that a primary amino group instead of the formamide group is attached to the polymer backbone. Suitable examples include polyvinyl formamides or derivatives thereof with a degree of formamide group hydrolysis of 10 to 100 mol %.

The number-average molar weight of the solution polymer is preferably greater than 500, more preferably greater than 1000, and with very particular preference greater than 1500 or 2000 g/mol; it is preferably not more than 200000 g/mol, more preferably not more than 130000 g/mol, and very preferably not more than 80000 g/mol or 50000 g/mol. In one very special embodiment the molar weight is no more than 20000 g/mol or not more than 15000 g/mol.

The solution polymer is in solution in the water of the polymer dispersion. The solubility of the solution polymer in the water is preferably at least 50 g, more preferably at least 100 g, very preferably at least 200 g of solution polymer per 1000 g of water (at 21° C.).

Suitable solution polymers are obtainable for example under the brand names Lupamin (polyvinylamine) or Mowiol (polyvinyl alcohol).

The solution polymer can be added simply to the dispersion of the polymer and dissolves readily in the water with stirring.

The mixture obtained is stable on storage.

The amount of the solution polymer is preferably 0.1 to 10 parts, more preferably 0.2 to 5 parts, very preferably 0.4 to 3 parts by weight per 100 parts by weight of the dispersed polymer.

### The Pressure-Sensitive Adhesive (PSA)

The PSA may be composed exclusively of the polymer, or of the aqueous dispersion of the polymer and the solution polymer.

The PSA comprises the polymer preferably in the form of the aqueous polymer dispersion as has been obtained, or is obtainable, by emulsion polymerization.

Alternatively the PSA may comprise further additives.

Suitable examples include a tackifier, i.e., a tackifying resin. Tackifiers are known for example from Adhesive Age, July 1987, pages 19-23 or Polym. Mater. Sci. Eng. 61 (1989), pages 588-592.

Tackifiers are, for example, natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight Mw of below 30000. The polyacrylates with preference are composed of at least 60%, in particular at least 80% by weight of C1-C8 alkyl (meth)acrylates.

Preferred tackifiers are natural or chemically modified rosins. Rosins are composed predominantly of abietic acid or abietic acid derivatives.

The tackifiers can be added in a simple way to the polymers of the invention, preferably to the aqueous dispersions of the polymers. In this case the tackifiers are preferably themselves in the form of an aqueous dispersion.

The amount by weight of tackifiers is preferably 5 to 100 parts by weight, more preferably 10 to 50 parts by weight, based on 100 parts by weight of polymer (solids/solids).

Besides tackifiers, for example, further additives may be present, examples being thickeners, preferably associative thickeners, defoamers, plasticizers, pigments, wetting agents or fillers, in the PSA.

For improved surface wetting the PSAs may comprise, in particular, wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, in particular 0.1 to 3 parts by weight, per 100 parts by weight of polymer (solids).

In accordance with the invention the PSAs are used for producing self-adhesive articles, especially film-backed labels.

The PSAs are suitable for producing self-adhesive articles such as labels, sheets or adhesives tapes. The PSA can be applied by typical methods, as for example by rolling, knifecoating, spreading, etc., to backings, examples being paper or polymeric films, composed preferably of polyethylene, polypropylene, which may have been biaxially or monoaxially oriented, polyethylene terephthalate, polyvinyl chloride, polystyrene, polyamide or metal. Suitable in particular are transparent backings, made for example of polyolefins, especially polyethylene or oriented polypropylene (oPP) or polyesters.

The water can be removed preferably by drying at 50 to 150° C. Before or after the adhesive is applied the backings may be slit to form adhesive tapes, labels or sheets. For subsequent use the PSA-coated side of the substrates may be lined with a release paper, e.g., with a siliconized paper.

The self-adhesive articles of the invention have very good adhesive properties, in particular an effective adhesion to the substrates and a high level of cohesion (internal strength in the adhesive layer).

In particular the PSAs of the invention are also suitable for transparent backings, and not least for film-backed labels, since the blushing phenomenon frequently accompanying water exposure does not occur, or is at least lessened. The performance properties are therefore effectively retained even on water exposure, with clouding or other impairment of the visual appearance being absent or barely observable.

### Performance Testing

### Preparation of Adhesives

### Starting Materials

Aqueous dispersions of a polyacrylate based on ethylhexyl acrylate (glass transition temperature of −24.6° C.).

Lupamin® 1595 SF, a water-soluble polyvinylamine (degree of hydrolysis 95%, i.e., 95% of the original vinylformamide units are present as vinylamine units in the polymer (molar weight less than 10000 g/mol).

Mowiol® 1579 (15% by weight in water), a water-soluble polyvinyl alcohol with a degree of hydrolysis of 79%, i.e., 79% of the original vinyl ether units are present as vinyl alcohol units in the polymer (molar weight less than 10000 g/mol).

The polyacrylate was subjected to diafiltration and then a defined amount of sodium sulfate (as 10% solution in water) was added (comparative experiments). In the case of the inventive experiments the same amount of sodium sulfate (as a 10% strength solution in water) and the solution polymer were added. Water was added to set the same water content in each case.

The PSAs were coated directly onto a polyester film backing, using a slotted doctor blade with a slot height of 60 μm, and the PSA-coated film backings were dried at 120° C. for 3 minutes.

Strips of the coated polyester film were immersed in water for a defined period of time, after which the visual appearance was evaluated using ratings from 0 to 4:

0: no clouding
1: very slight clouding
2: more severe clouding
3: severe clouding
4: very severe clouding

TABLE
Results
% figures are % by weight

| Immersion time | | | | | |
|---|---|---|---|---|---|
| in water, in | | | +5% | | +15% |
| seconds (s), in | | | NaSO4 | | NaSO4 |
| minutes (min), | | +5% | +1% | +15% | +2% Lu- |
| or in hours (h) | | NaSO4 | Mowiol | NaSO4 | pamin |
| 10 | s | 0 | 0 | 1 | 1 |
| 30 | s | 0 | 0 | 1 | 1 |
| 60 | s | 0 | 0 | 1–2 | 1 |
| 3 | min | 1 | 0–1 | 2 | 1–2 |
| 5 | min | 1–2 | 1 | 3 | 2 |
| 10 | min | 2 | 2 | 4 | 3 |

1. The use of an aqueous pressure-sensitive adhesive for producing a self-adhesive article, wherein the aqueous pressure-sensitive adhesive comprises a water-dispersed polymer binder (polymer for short) and a water-dissolved polymer containing hydrophilic groups selected from primary amino groups and hydroxyl groups (solution polymer for short).

2. The use according to claim 1, wherein the polymer is a polymer which is obtainable by free-radical addition polymerization and which is composed of at least 60% by weight of what are called principal monomers, selected from C₁ to C₂₀ alkyl(meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, or mixtures of these monomers.

3. The use according to claim 1 or 2, wherein the polymer is an emulsion polymer and is composed of at least 60% by weight of C₁ to C₂₀ alkyl(meth)acrylates.

4. The use according to any one of claims 1 to 3, wherein the solution polymer comprises at least 0.05 mol of hydrophilic groups per 100 g of solution polymer.

5. The use according to any one of claims 1 to 4, wherein the solution polymer comprises at least 0.15 mol of hydrophilic groups per 100 g of solution polymer.

6. The use according to any one of claims 1 to 5, wherein the solution polymer has a number-average molar weight of 500 to 200000.

7. The use according to any one of claims 1 to 6, wherein the solution polymer has a solubility of at least 50 g of solution polymer per 1000 g of water (at 21° C.).

8. The use according to any one of claims 1 to 7, wherein the amount of solution polymer is 0.05 to 10 parts by weight per 100 parts by weight of the dispersed polymer.

9. A self-adhesive article obtainable through use according to any one of claims 1 to 8.

10. A film-backed label obtainable through use according to any one of claims 1 to 8.

11. A film-backed label according to claim 10 having a polyolefin or polyester film backing.

12. A film-backed label according to claim 10 having a polyethylene or oPP (oriented propylene) film backing.
